(19) United States
(12) Patent Application Publication
(10) Pub. No.: US 2026/0131264 A1
(43) Pub. Date: May 14, 2026

(54) FLUID FILTER MODULE

(71) Applicant: MAHLE International GmbH, Stuttgart (DE)

(72) Inventors: Edson Valdomiro De Azevedo, Shelby Township, MI (US); Fernando Yoshino, Oakland Township, MI (US)

(21) Appl. No.: 18/944,892

(22) Filed: Nov. 12, 2024

(51) Int. Cl. B01D 29/07

(52) U.S. Cl. CPC B01D 29/071; B01D 2201/0415; B01D 2201/301

(57) ABSTRACT

A fluid filter module for a motor vehicle may include a housing shell and a filter. The housing shell may be cup-shaped. The filter may be disposed at least partially in the housing shell. The housing shell and the filter may be connected to one another and may collectively define a housing. The filter may divide an internal space of the housing into an unfiltered region and a filtered region. The housing may include an inlet and an outlet. The filter may include a filter frame and a filter media configured to at least one of remove and collect impurities from the fluid. The unfiltered region and the filtered region may be fluidically connected to one another via the filter media. The filter frame may be connected to the filter media and may include a frame wall that closes an open end of the housing shell.

### TECHNICAL FIELD

The present disclosure generally relates to fluid filter modules that may, for example, be used in connection with transmission systems (e.g., for traction motors), internal combustion engines, and/or motor vehicles.

### BACKGROUND

Conventional fluid filter module designs utilize several parts and/or components to enclose a filter and to direct a fluid (e.g., transmission oil) through the filter for filtration. For example, some conventional filter modules enclose a filter in a multi-part housing. The filter is disposed in a first housing part and covered by a second housing part. The first housing part, second housing part, and filter are then connected to one another via welding (e.g., vibration welding). Welding of the two housing parts results in formation of a seam between the two housing parts that is a potential point of failure that is (e.g., more) susceptible to undesired leaking and/or breakage. Moreover, each part and/or component included in the conventional fluid filter module design requires tooling, its own processing equipment, and adds additional steps to the process of assembling the module. Therefore, as the number of parts and/or components increases, so does the cost to produce the conventional fluid filter module. This is important as keeping costs to a minimum is a key component of market competitiveness.

Accordingly, there is a need for an improved fluid filter module that minimizes or eliminates one or more challenges or shortcomings of existing fluid filter modules.

### SUMMARY

A fluid filter module for a motor vehicle may include a housing shell and a filter. The housing shell may be cup-shaped. The filter may be disposed at least partially in the housing shell. The housing shell and the filter may be connected to one another and may collectively define a housing. The filter may divide an internal space of the housing into an unfiltered region and a filtered region. The housing may include i) an inlet via which a fluid is flowable into the unfiltered region and ii) an outlet via which the fluid is flowable out of the filtered region. The filter may include i) a filter frame and ii) a filter media configured to at least one of remove and collect impurities from the fluid. The unfiltered region and the filtered region may be fluidically connected to one another via the filter media. The filter frame may be connected to the filter media and may include a frame wall that closes an open end of the housing shell.

A fluid filter module for a motor vehicle may include a monolithic housing shell and a filter. The housing shell may be cup-shaped. The filter may be disposed at least partially in the housing shell. The housing shell and the filter may be connected to one another and may collectively define a housing. The filter may divide an internal space of the housing into an unfiltered region and a filtered region. The housing may include i) an inlet via which a fluid is flowable into the unfiltered region and ii) an outlet via which the fluid is flowable out of the filtered region. The filter may include i) a filter frame and ii) a filter media configured to at least one of remove and collect impurities from the fluid. The unfiltered region and the filtered region may be fluidically connected to one another via the filter media. The filter frame may be connected to the filter media and may include a frame wall that closes an open end of the housing shell. The housing may further include a plurality of access openings via which the filter is accessible to be at least one of pressed and clamped against the housing shell when connecting the housing shell and the filter to one another.

Various other features and advantages will be made apparent from the following detailed description and the drawings.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a perspective view of a first exemplary fluid filter module;

FIG. 2 is a perspective view of the housing shell of the first fluid filter module of FIG. 1;

FIGS. 3 and 4 are perspective views of the filter of the first fluid filter module of FIG. 1;

FIGS. 5 and 6 are cross-sectional views of the first fluid filter module of FIG. 1;

FIG. 7 is a perspective view of a second exemplary fluid filter module;

FIG. 8 is a perspective view of the filter of the second fluid filter module of FIG. 7;

FIG. 9 is a cross-sectional view of the second fluid filter module of FIG. 7;

FIG. 10 is a perspective view of a third exemplary fluid filter module;

FIG. 11 is a cross-sectional view of the third fluid filter module of FIG. 10;

FIG. 12 is a perspective view of a fourth exemplary fluid filter module;

FIG. 13 is a cross-sectional view of the fourth fluid filter module of FIG. 12;

FIG. 14 is a perspective view of a fifth exemplary fluid filter module;

FIG. 15 is a perspective view of the housing shell of the fifth fluid filter module of FIG. 14;

FIGS. 16 and 17 are perspective views of the filter of the fifth fluid filter module of FIG. 14; and

FIGS. 18 and 19 are cross-sectional views of the fifth fluid filter module of FIG. 14.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

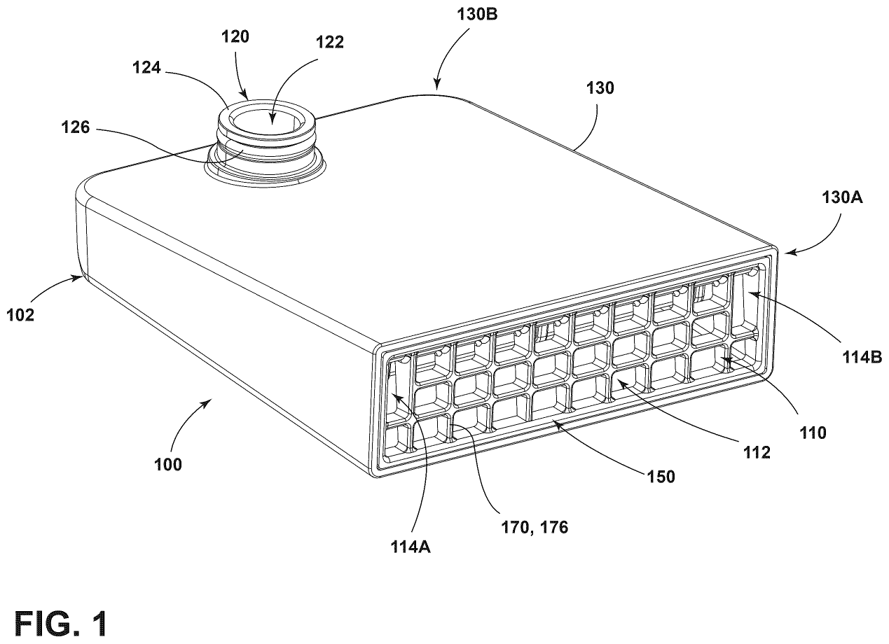

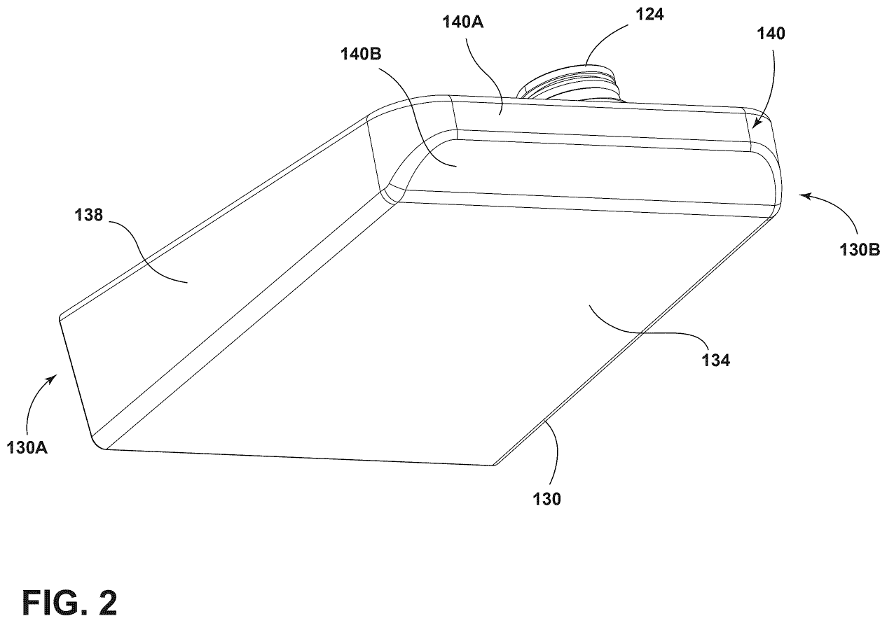

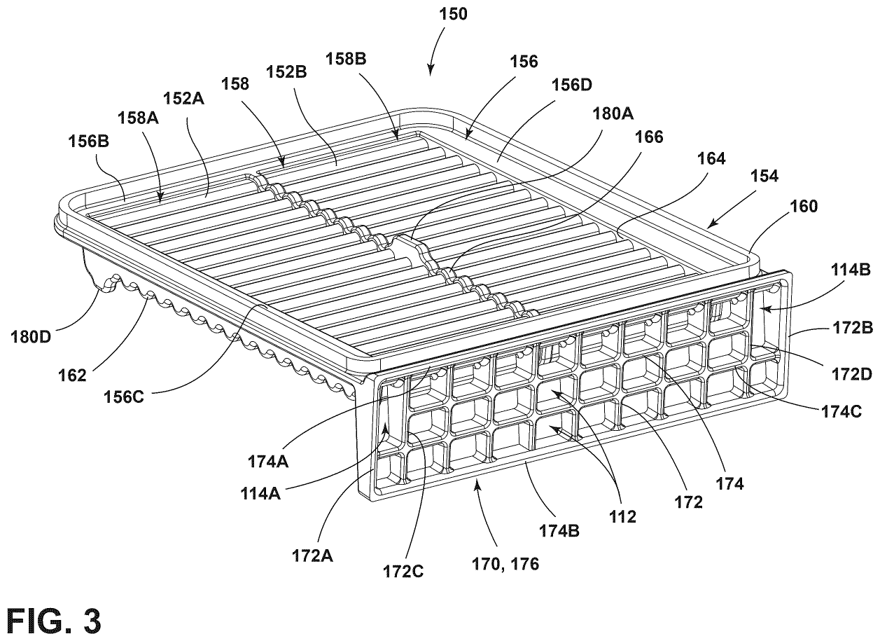

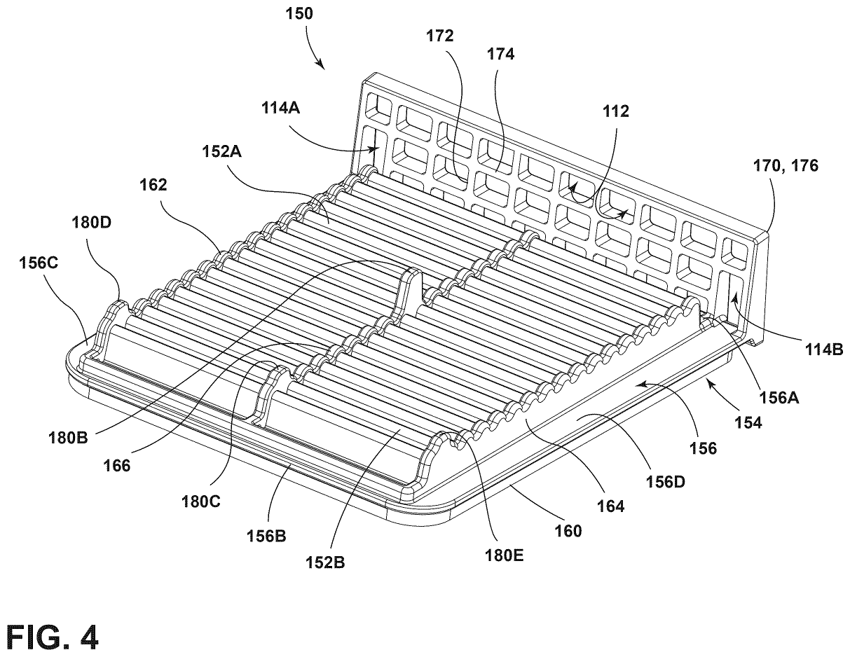

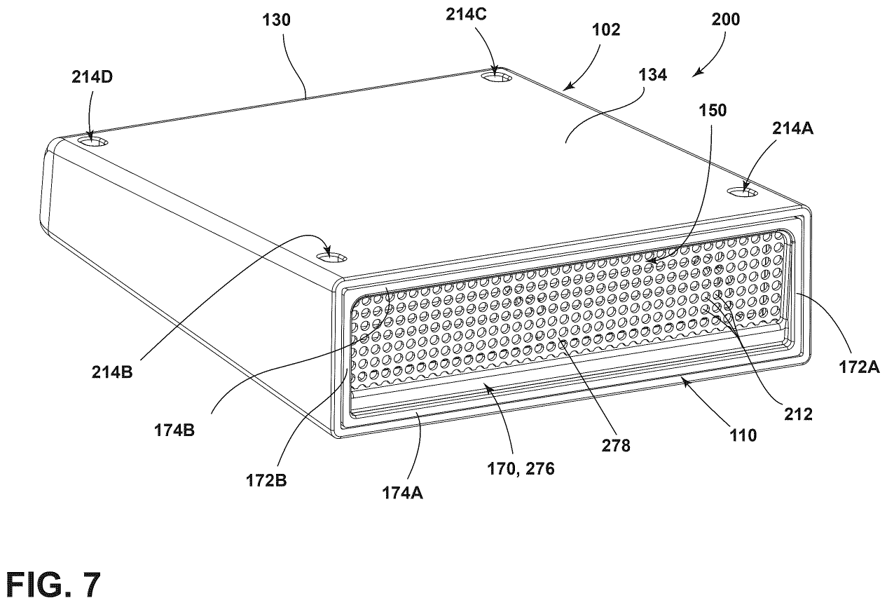

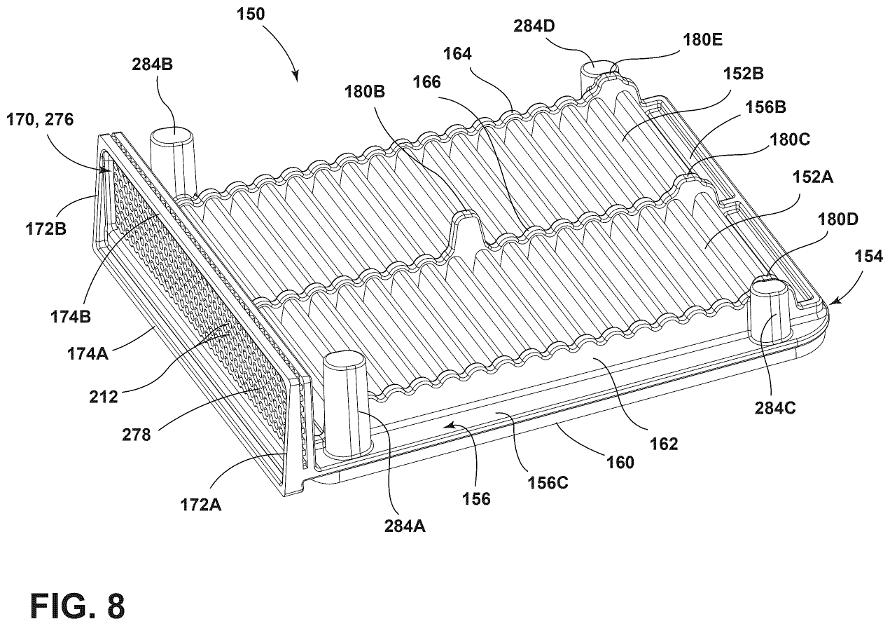

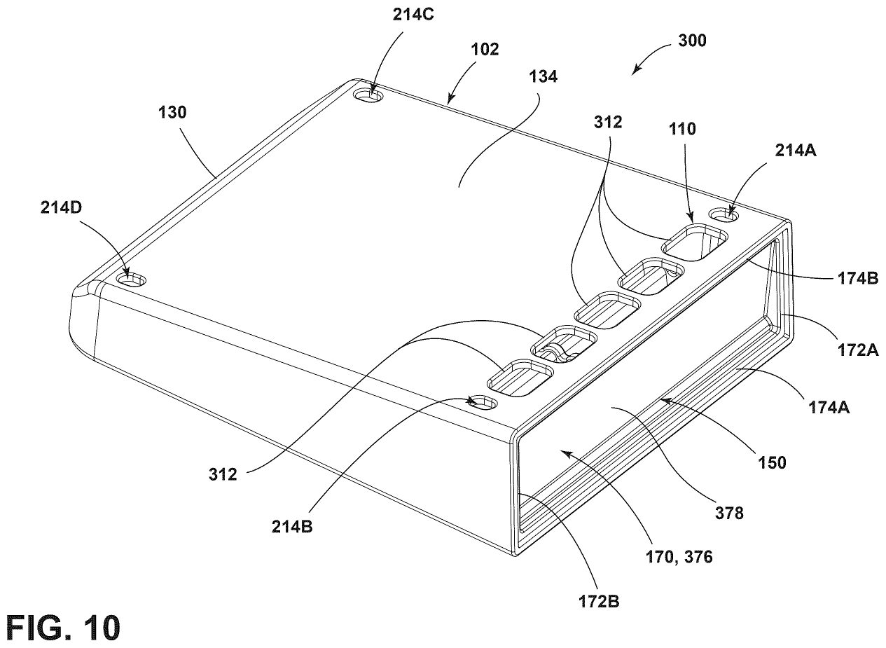

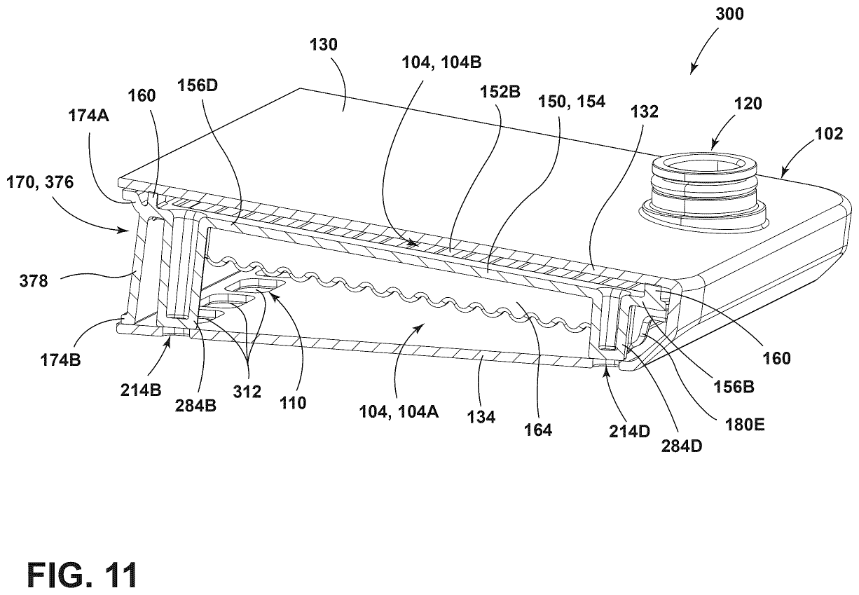

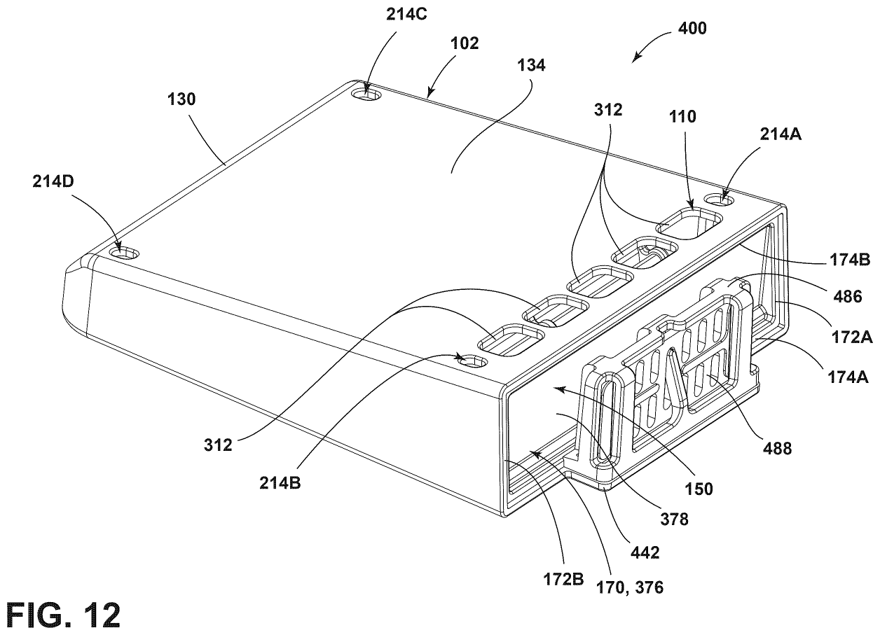

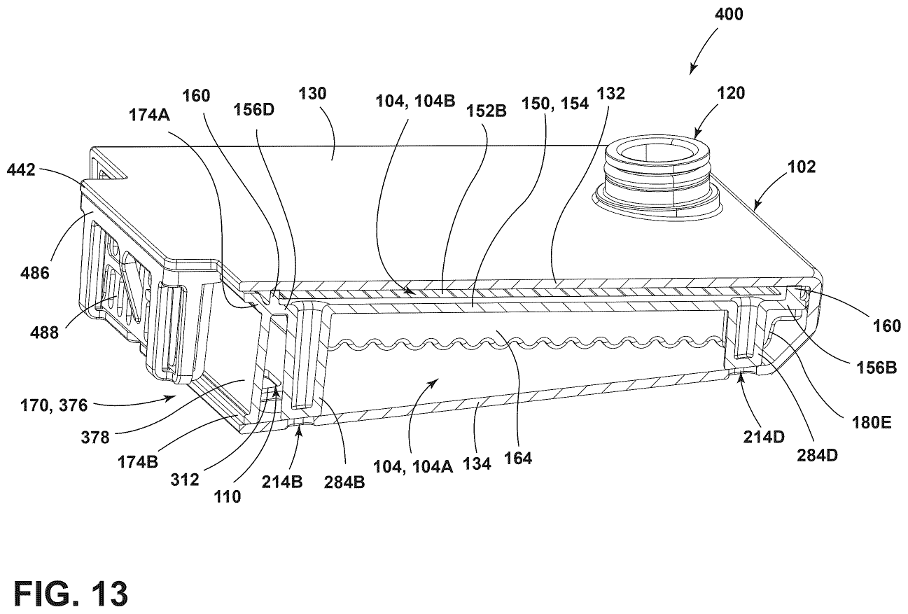

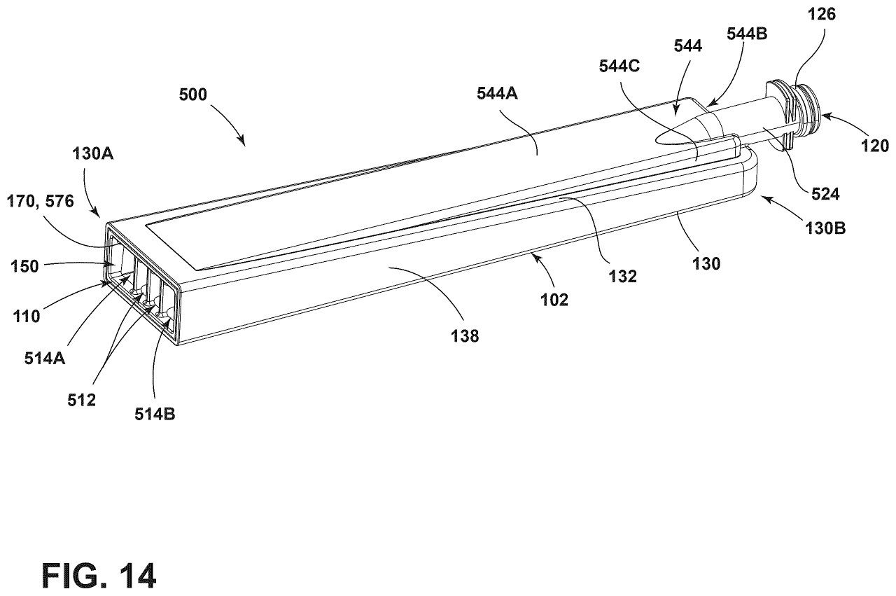

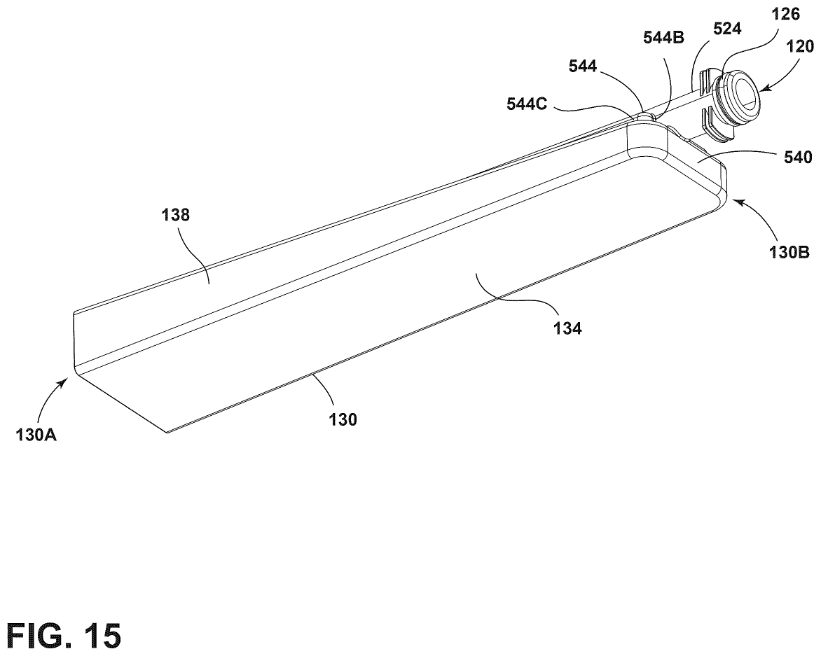

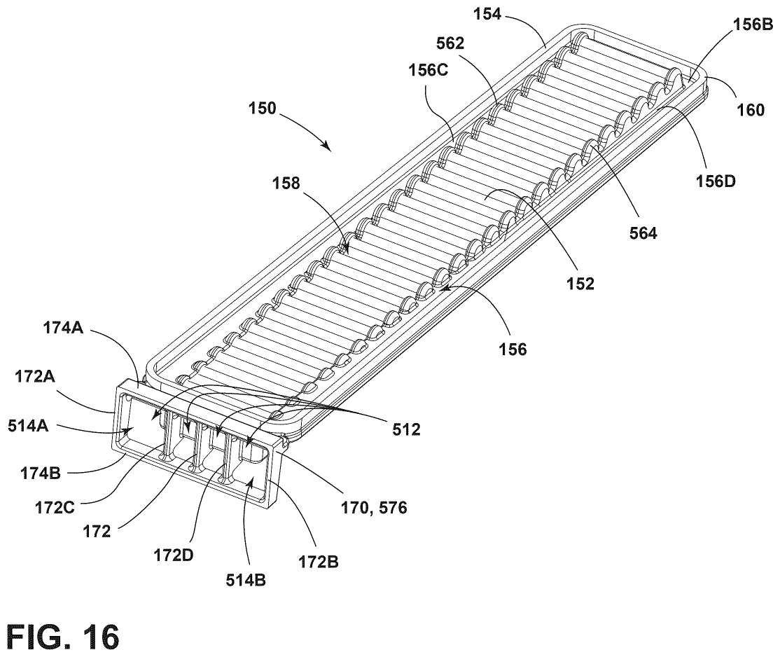

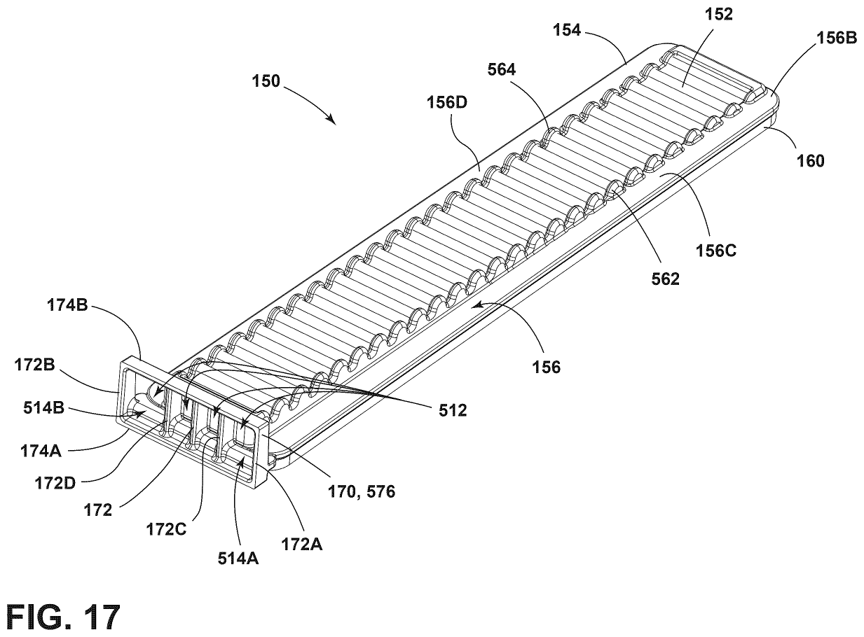

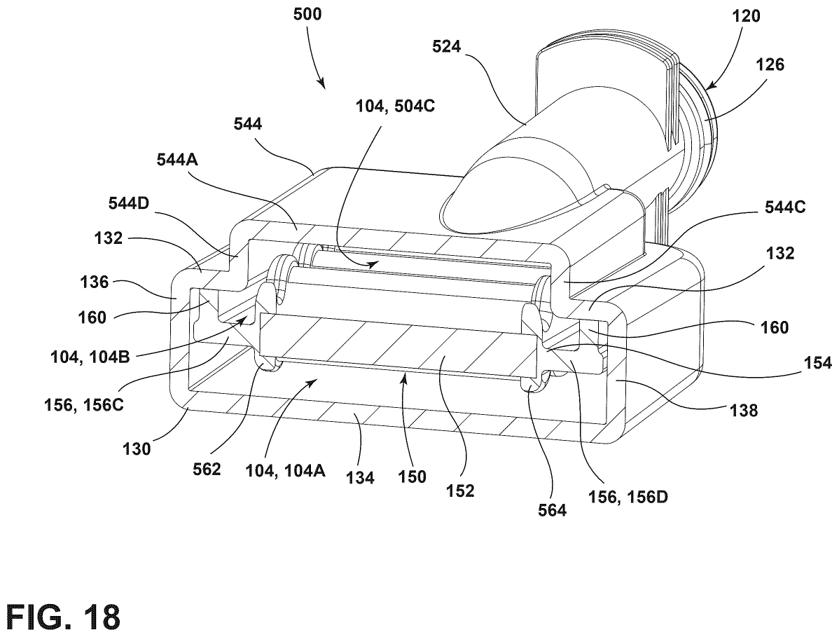

Disclosed is a fluid filter module 100, 200, 300, 400, 500 (e.g., a transmission oil filter module) that may, for example, be used in connection with transmission systems (e.g., for traction motors), internal combustion engines, and/or motor vehicles. The module 100, 200, 300, 400, 500 is configured to conduct a throughflow of a fluid (e.g., transmission oil) and to remove and/or collect impurities from the fluid flowing through the module 100, 200, 300, 400, 500. A first exemplary fluid filter module 100 is depicted in FIGS. 1-6. A second exemplary fluid filter module 200 is depicted in FIGS. 7-9. A third exemplary fluid filter module 300 is depicted in FIGS. 10 and 11. A fourth exemplary fluid filter module 400 is depicted in FIGS. 12 and 13. A fifth exemplary fluid filter module 500 is depicted in FIGS. 14-19. It will be appreciated that the advantages and/or benefits described below with respect to one or more of the exemplary fluid filter modules 100, 200, 300, 400, 500 is also applicable to any of the other exemplary fluid filter modules 100, 200, 300, 400, 500 including the same and/or similar features, elements, etc. that provide and/or achieve the advantage and/or benefit.

With regard to FIGS. 1-6, the first exemplary fluid filter module 100 includes a housing 102, a housing shell 130, a filter 150 (e.g., a filter assembly and/or subassembly), an inlet 110, an outlet 120, one or more access openings 114A, 114B, and a seal 126. The housing shell 130 is a cup-shaped monolithic body. The filter 150 is disposed at least partially within the housing shell 130 and closes the housing shell 130 (e.g., a frame wall 170 of the filter 150 closes an opening and/or open end 130A of the housing shell 130). The housing shell 130 and the filter 150 are connected (e.g., via a laser weld and/or a laser weld connection) to one another to form and/or define the housing 102. The access openings 114A, 114B provide access (e.g., clamping access) to the portion of the filter 150 disposed within the housing shell 130 so that the filter 150 can be pressed and/or clamped against the housing shell 130 when connecting (e.g., laser welding) the filter 150 and the housing shell 130. In at least some examples (e.g., modules 100, 500), after the housing shell 130 and the filter 150 have been connected, the access openings 114A, 114B serve as and/or function the same as inlet openings 112 of the inlet 110.

The housing shell 130 and the filter 150 (e.g., the frame wall 170) collectively define and/or form the housing 102 of the module 100. The housing 102 includes and/or defines an internal space 104. At least a portion of the filter 150 (e.g., the base body 156 and the filter medias 152A, 152B) is disposed within the internal space 104 of the housing 102 and divides the internal space 104 into an unfiltered region 104A and a filtered region 104B. The unfiltered region 104A and the filtered region 104B are in fluid communication with one another (e.g., exclusively) via the filter 150 (e.g., the medias 152A, 152B). The inlet 110 (e.g., the inlet openings 112) and the access openings 114A, 114B open into the unfiltered region 104A, while the outlet 120 (e.g., outlet opening 122) opens into the filtered region 104B. The fluid is flowable into the module 100, the housing 102, and/or the unfiltered region 104A of the internal space 104 via the inlet 110. The fluid in the unfiltered region 104A is flowable through the filter 150 (e.g., the filter medias 152A, 152B) and into the filtered region 104B of the internal space 104. The fluid is filtered (e.g., impurities contained in the fluid are removed and/or collected) by the filter 150 as the fluid passes and/or flows through the filter 150 (e.g., the filter medias 152A, 152B) from the unfiltered region 104A to the filtered region 104B. The fluid is flowable out of the module 100, the housing 102, and/or the filtered region 104B of the internal space 104 via the outlet 120.

Due to the monolithic construction of the housing shell 130 and the filter frame 154 of the filter 150, the disclosed fluid filter module 100 includes fewer components and/or parts than conventional fluid filter modules. The module 100 thus involves less tooling, less processing equipment, and fewer steps to assemble than conventional fluid filter modules and, as such, enables the disclosed module 100 to be produced at a reduced cost compared to conventional fluid filter modules. The housing 102 is also less susceptible to leakage and/or breakage than conventional fluid filter modules since the housing 102 has less and/or fewer seams due to the monolithic construction of the housing shell 130 that is free of seams. In addition, the housing shell 130 and the filter 150 (e.g., the filter frame 154) are connected by a single laser weld joint, which reduces processing costs and simplifies manufacturing and assembly. The module 100 is also highly customizable and allows for multiple design variations while maintaining the same profile for the laser weld joint. By utilizing the same profile for the laser weld joint across multiple design variations, production costs are further reduced.

The inlet 110 includes a plurality of inlet openings 112 through which the fluid is flowable into housing 102 and/or the unfiltered region 104A of the internal space 104. The inlet openings 112 are disposed in and defined by the housing 102. The inlet openings 112 are disposed in and/or defined by the filter 150 (e.g., the frame wall 170) in some examples (see, e.g., FIGS. 1-9 and 14-19).

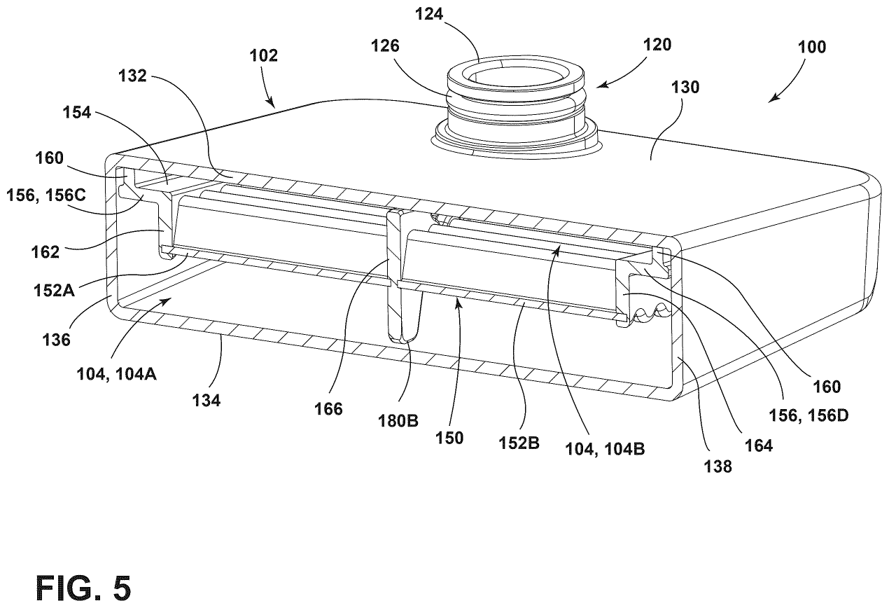

The outlet 120 and/or the housing shell 130 includes an outlet opening 122 through which the fluid is flowable out of housing 102 and/or the filtered region 104B of the internal space 104. The outlet opening 122 is disposed in and defined by the housing 102 and/or the housing shell 130. The outlet 120 and/or the housing shell 130 further includes an outlet connector 124 via which the module 100, the housing 102, and/or the housing shell 130 is connectable to one or more other components that receive the filtered fluid from the module 100. The outlet connector 124 is a generally annular body that projects from the housing shell 130 (e.g., the top wall 132 and/or the scoop portion 544) and extends around an outer perimeter of the outlet opening 122. The seal 126 (e.g., an O-ring seal) is disposed on and extends circumferentially around an exterior and/or outer circumference of the outlet connector 124. The seal 126 is arranged and/or received in a circumferential groove disposed in and/or defined by the outlet connector 124. In some examples (see, e.g., FIGS. 1-13), the outlet opening 122 is disposed in and/or defined by top wall 132 of the housing shell 130 and the outlet connector 124 protrudes from the top wall 132 in a direction that is substantially perpendicular to a central longitudinal axis of the housing shell 130, substantially parallel to the open end 130A of the housing shell 130 (see, e.g., FIG. 5), and/or transverse to the top wall 132 and the bottom wall 134.

The housing shell 130 is a generally cup-shaped, monolithic body having an opening and/or open end 130A (e.g., a single open end 130A). The housing shell 130 has a generally trapezoidal shape (e.g., as viewed in a top-down view, bottom-up view, and side view) and/or a generally trapezoidal shaped cross-section in one or more planes perpendicular to the open end 130A of the housing shell 130 (e.g., a first plane extending between the top and bottom walls 132, 134, and a second plate extending between the first and second sidewalls 136, 138). The trapezoidal shape of the housing shell 130 and/or the cross-sections thereof allows for better control of the fluid flow velocity through the module 100 and reduces the pressure drop experienced as the fluid flows through the module 100. Moreover, the generally trapezoidal shape has been found to facilitate formation of the monolithic housing shell 130 via injection molding, particularly removal and/or decoupling of the housing shell 130 from the mold.

The housing shell 130 includes a top wall 132, a bottom wall 134 disposed opposite the top wall 132, and one or more sidewalls 136, 138, 140 that extend between and connect the top wall 132 and the bottom wall 134. The top wall 132 and the bottom wall 134 are generally planar bodies that are trapezoidal in shape. The long/major end of the top wall 132 and the long/major end of the bottom wall 134 are disposed at and/or partially define the open end 130A of the housing shell 130, while the short/minor end of the top wall 132 and the short/minor end of the bottom wall 134 are disposed at a closed end 130B of the housing shell 130 opposite the open end 130A. The top wall 132 and the bottom wall 134 extend transversely (e.g., obliquely) relative to one another such that the distance between the top wall 132 and the bottom wall 134 is larger at the open end 130A of the housing shell 130 than at the closed end 130B. One or more of the sidewalls 136, 138 (e.g., a first sidewall 136 and a second sidewall 138) are also generally planar bodies that are trapezoidal in shape. The first and second sidewalls 136, 138 extend transversely and/or perpendicular to the top wall 132 and the bottom wall 134 such that the open end 130A of the housing shell 130 and a cross-sectional profile of the internal space 104 of the housing 102 are generally rectangular in shape (see, e.g., FIG. 5). The sidewall 140 disposed opposite the open end 130A of the housing shell 130 (i.e., disposed at the closed end 130B), which may be referred to as a third sidewall and/or an end wall, has an angled configuration. The end wall 140 includes a first end wall portion 140A and a second end wall portion 140B. The first end wall portion 140A extends from the top wall 132 to the second end wall portion 140B and lies transversely (e.g., obliquely) relative to the top wall 132 and the second end wall portion 140B. The second end wall portion 140B extends from the bottom wall 134 to the first end wall portion 140A and lies transversely (e.g., obliquely) relative to the bottom wall 134 and to the first end wall portion 140A. The angle defined by and between the second end wall portion 140B and the bottom wall 134 is larger than the angle defined by and between the first end wall portion 140A and the top wall 132. The length of the second end wall portion 140B in a direction parallel to the central longitudinal axis of the housing shell 130 is greater than the length of the first end wall portion 140A. This enables the distance between the top wall 132 and the bottom wall 134 to shirk and/or narrow more gradually. Alternatively, the end wall 140 may be curved rather than angled. The angled or curved configuration of the end wall 140, in at least some examples, facilitates and/or is advantageous with respect to tooling of the housing shell 130.

The filter 150, which may be a filter assembly and/or subassembly, includes one or more filter medias 152A, 152B and a filter frame 154 that is connected to and/or retains the filter medias 152A, 152B. The filter medias 152A, 152B are configured to remove and/or collect impurities from the fluid flowing through the module 100. The filter medias 152A, 152B are each a pleated filter media in the illustrative examples herein, though it will be appreciated that one or more of the filter medias 152A, 152B may have other shapes and/or configurations.

The filter frame 154 includes a base body 156, a perimeter wall 160, a plurality of retainer walls 162-166, and a frame wall 170. Optionally, the filter frame 154 also includes one or more supports 180A-180E. The filter frame 154 and the elements thereof (e.g., the base body 156, perimeter wall 160, retainer walls 162-166, frame wall 170, and supports 180A-180E) are configured, structured, and/or integrally provided as a monolithic body and/or component. The filter frame 154 is connected to the housing shell 130 via laser welding (e.g., via a laser weld). The access openings 114A, 114B provide access (e.g., clamping access) to the portion of the filter frame 154 disposed inside the housing shell 130 (e.g., the base body 156) so that the filter frame 154 (e.g., the perimeter wall 160) can be pressed and/or clamped against the top wall 132 of the housing shell 130 for and/or during laser welding of the filter frame 154 to the housing shell 130.

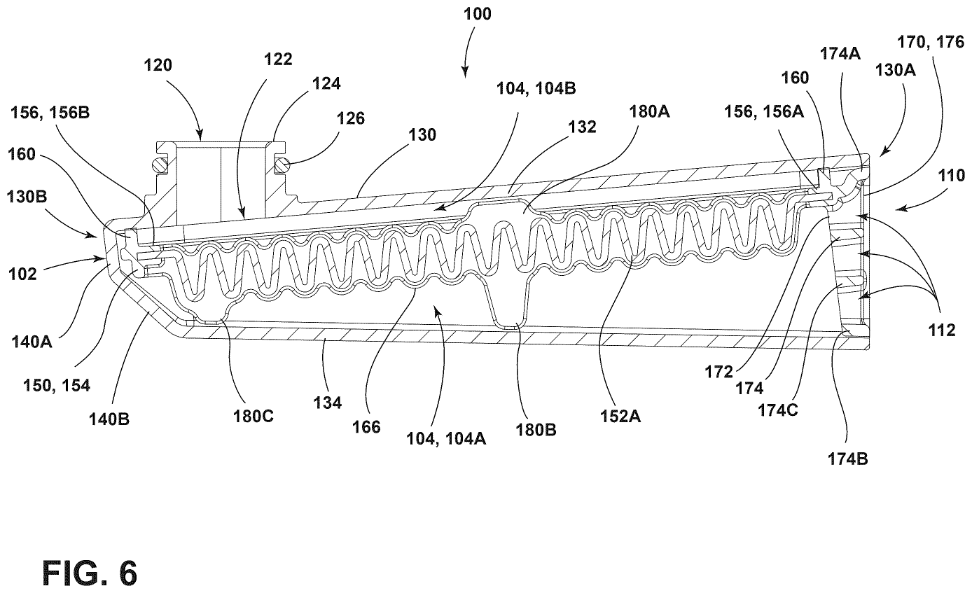

The base body 156 of the filter frame 154 is generally planar and has a trapezoidal ring shape, though other shapes are conceivable. The base body 156 extends generally parallel to the top wall 132 of the housing shell 130 (see, e.g., FIG. 6). The base body 156 includes and/or defines an opening 158, which forms and/or defines an inner perimeter of the base body 156. The opening 158 is generally rectangular, but may be other appropriate shapes, such as trapezoidal. One or more filter medias 152 is disposed and/or retained in the opening 158, which may be divided into one or more media receptacles 158A, 158B (e.g., via one or more retainer walls 166). The base body 156 includes a plurality of portions including a first portion 156A, a second portion 156B, a third portion 156C, and a fourth portion 156D. A length of the first portion 156A is greater than a length of the second portion 156B. The first portion 156A and the second portion 156B are disposed opposite one another, while the third portion 156C and the fourth portion 156D are disposed opposite one another. The third and fourth portions 156C, 156D extend between and connect the first and second portions 156A, 156B of the base body 156 forming a trapezoidal ring shape. The first, second, third, and fourth portions 156A-156D of the base body 156 collectively define the opening 158. Optionally, the base body 156 (e.g., the second, third, and fourth portions 156B-156D) contact and/or abut the housing shell 130 (e.g., the end wall 140, first sidewall 136, and second sidewall 138, respectively), which further secures the filter 150 within the housing shell 130.

The perimeter wall 160 is disposed on and projects from the base body 156 away from unfiltered region 104A and/or transversely (e.g., obliquely or perpendicularly) to the base body 156. The perimeter wall 160 extends around the base body 156 and follows (e.g., mirrors) the outer perimeter and/or the inner perimeter of the base body 156. The perimeter wall 160 is arranged between (e.g., disposed spaced apart from and/or concentrically with) the outer perimeter and the inner perimeter of the base body 156 in the illustrative examples herein, but may alternatively be arranged at the outer perimeter or the inner perimeter of the base body 156. The perimeter wall 160 sealing contacts and/or abuts the top wall 132 of the housing shell 130 and partially defines the filtered region 104B of the internal space 104. The perimeter wall 160 is connected to the top wall 132 of the housing shell 130 via laser welding and/or a laser weld, which provides a fluid tight seal between the filtered region 104B and the unfiltered region 104A of the internal space 104.

The retainer walls 162-166 project from the base body 156 into the unfiltered region 104A of the internal space 104 (i.e., in a direction opposite the perimeter wall 160). The retainer walls 162-166 include a first retainer wall 162, a second retainer wall 164, and one or more optional third retainer walls 166. The first retainer wall 162 is disposed on a first side of the base body 156, protrudes from the third portion 156C of the base body 156, and extends along a first side of the opening 158, which is defined and/or delimited by the third portion 156C of the base body 156. The second retainer wall 164 is disposed on an opposite, second side of the base body 156, protrudes from the fourth portion 156D of the base body 156, and extends along a second side of the opening 158, which is defined and/or delimited by the fourth portion 156D of the base body 156. The third retainer wall 166 is disposed between the first retainer wall 162 and the second retainer wall 164. The third retainer wall 166 extends between and connects the first portion 156A and the second portion 156B of the base body 156. The third retainer wall 166 divides the opening 158 into a first media receptacle 158A and a second media receptacle 158B. The first media receptacle 158A is defined at least partially by the first retainer wall 162, the third retainer wall 166, the first portion 156A, and the second portion 156B. The second media receptacle 158B is defined at least partially by the second retainer wall 164, the third retainer wall 166, the first portion 156A, and the second portion 156B. A first filter media 152A is disposed and/or retained in the first media receptacle 158A and is connected to one or more of the first retainer wall 162, the third retainer wall 166, and the base body 156 (e.g., the first and/or second portions 156A, 156B). A second filter media 152B is disposed and/or retained in the second media receptacle 158B and is connected to one or more of the second retainer wall 164, the third retainer wall 166, and the base body 156 (e.g., the first and/or second portion 156A, 156B). While the illustrative examples of FIGS. 1-13 include a single third retainer wall 166, two media receptacles 158A, 158B, and two filter media 152A, 152B, the module 100 may include other desired numbers of retainer walls, media receptacles, and filter medias.

The frame wall 170 closes the open end 130A of the housing shell 130 and partially defines and/or forms the housing 102 when the filter 150 is arranged in and/or connected to the housing shell 130. The frame wall 170 also partially defines and/or delimits the unfiltered region 104A of the internal space 104. The frame wall 170 is disposed on and connected (e.g., integrally) to the first portion 156A of the base body 156. The frame wall 170 projects transversely from the first portion 156A of the base body 156 in a direction opposite the perimeter wall 160 and/or toward the bottom wall 134 of the housing shell 130.

The frame wall 170 includes a plurality of members, bars, and/or slats 172, 174. The plurality of members 172, 174 includes a plurality of first and/or vertical members 172 and a plurality of second and/or horizontal members 174. The first members 172 extend transversely to the first portion 156A of the base body 156, transversely (e.g., perpendicularly) to the second members 174, generally parallel to the first and second sidewalls 136, 138 of the housing shell 130, and/or generally parallel to one another. The second members 174 extend transversely (e.g., perpendicularly) to the first members 172, generally parallel to the first portion 156A of the base body 156 and generally parallel to the top wall 132, the bottom wall 134, and/or to one another. The first and second members 172, 174 intersect each other to form a grid and/or lattice pattern. As such, the frame wall 170 may be considered and/or referred to as a lattice frame wall 176.

The inlet openings 112 are disposed in and defined by the frame wall 170. Due to the presence of the inlet openings 112 in the frame wall 170 (e.g., in modules 100, 200, 500), the frame wall 170 does not fluidically seal the open end 130A of the housing shell 130. Each of the inlet openings 112 is formed and/or defined by the space and/or gap between two adjacent first members 172 and two adjacent second members 174 extending between the two adjacent first members 172. The filter 150, filter frame 154, and/or frame wall 170 thus includes and/or defines the inlet 110 of the module 100. In examples where the frame wall 170 includes the inlet 110 (e.g., modules 100, 200, 500), the filter wall 170 and/or the members 172, 174 thereof form and/or act as an inlet filter and/or protection grid that blocks, limits, and/or restricts debris or other objects from entering the housing 102 and/or the internal space 104.

The access openings 114A, 114B are disposed in and defined by the frame wall 170. A first access opening 114A is formed and/or defined by a fixed-end second member 174A, an adjacent second member 174C, a first-side first member 172A, and a first member 172C disposed directly adjacent to the first-side first member 172A. A second access opening 114B is formed and/or defined by the fixed-end second member 174A, an adjacent second member 174C, a second-side first member 172B, and a first member 172D disposed directly adjacent to the second-side first member 172B. The first and second access openings 114A, 114B are both partially defined by the same second member 174C in the illustrative examples herein, though this is not required.

The fixed-end second member 174A is the second member 174 of the frame wall 170 that is (i) disposed at and/or forms a fixed end of the frame wall 170 connected and/or fixed to the base body 156 and/or (ii) disposed closest to and/or in contact with the top wall 132 of the housing shell 130. A free-end second member 174B is the second member 174 of the frame wall 170 that is (i) disposed at and/or forms a fee end of the frame wall 170 opposite the fixed end of the frame wall 170 and/or the base body 156 and/or (ii) disposed closest to and/or in contact with the bottom wall 134 of the housing shell 130. The first-side first member 172A is the first member 172 of the frame wall 170 that is (i) disposed at and/or forms a side and/or end of the frame wall 170 opposite the second-side first member 172B and/or (ii) disposed closest to and/or in contact with the first sidewall 136 of the housing shell 130. The second-side first member 172B is the first member 172 of the frame wall 170 that is (i) disposed at and/or forms a side and/or end of the frame wall 170 opposite the first-side first member 172A and/or (ii) disposed closest to and/or in contact with the second sidewall 138 of the housing shell 130. The first-side first member 172A and the second-side first member 172B extend between and connect the fixed-end second member 174A and the free-end second member 174B. The fixed-end second member 174A, free-end second member 174B, first-side first member 172A, and second-side first member 172B extend around and/or define the outer perimeter of the frame wall 170.

The adjacent first member 172C is aligned with the first retainer wall 162 and/or the first access opening 114A is aligned with the third portion 156C of the base body 156. The adjacent first member 172D is aligned with the second retainer wall 164 and/or the second access opening 114B is aligned with the fourth portion 156D of the base body 156. As such, a first and second clamping member are insertable into the internal space 104 (e.g., the unfiltered region 104A) through the first and second access openings 114A, 114B, respectively, and can be moved into contact with and/or pressed against the third portion 156C and the fourth portion 156D of the base body 156, respectively, to clamp the filter frame 154 against the housing shell 130 when laser welding the filter 150 and housing shell 130 together. A cross-sectional area of the first access opening 114A and the second access opening 114B is generally larger than that of the inlet openings 112 to better accommodate movement of the clamping members (e.g., toward and/or away from the base body 156) when clamping and/or unclamping the filter frame 154 to the housing shell 130 during laser welding. After the housing shell 130 and the filter 150 have been connected (e.g., laser welded), the access openings 114A, 114B serve as and/or function the same as inlet openings 112 of the inlet 110.

The supports 180A-180E support the filter 150 and/or the housing shell 130 and, to at least an extent, resist deformation of the housing shell 130 (e.g., to prevent the housing shell 130 from collapsing and/or from impeding and/or blocking fluid flow through the module 100). The supports 180A-180E are disposed on and protrude from the retainer walls 162-166. The supports 180A-180E are portions and/or extensions of the retainer walls 162-166 and integrally formed with the respective retainer wall 162-166. Additionally and/or alternatively, one or more of the supports 180A-180E may be disposed on, protrude from, and/or integrally formed with one or more portions 156A-156D of the base body 156. The supports 180A-180E (e.g., their free ends disposed opposite the base body 156) are disposed slightly spaced apart from the housing shell 130 (e.g., do not contact and/or abut the housing shell 130). Alternatively, one or more (e.g., each and/or all) of the supports 180A-180E contact and/or rest on the housing shell 130. A first subset of the supports (e.g., support 180A) project into the filtered region 104B of the internal space 104 and are disposed adjacent to and/or contact the top wall 132 of the housing shell 130. A second subset of the supports (e.g., supports 180B-180D) project into the unfiltered region 104A of the internal space 104 and are disposed adjacent to and/or contact the bottom wall 134 of the housing shell 130.

The filter frame 170 includes five supports 180A-180E (e.g., a first support 180A, a second support 180B, a third support 180C, a fourth support 180D, and a fifth support 180E), though any number of supports 180 is conceivable. The first support 180A is disposed at or about a middle and/or center of the third retainer wall 166 and projects into the filtered region 104B. The second support 180B is disposed at or about a middle and/or center of the third retainer wall 166 (i.e., opposite the first support 180A) and projects into the unfiltered region 104A. The third support 180C is disposed at or about an end of the third retainer wall 166 connected to the second portion 156B of the base body 156 and projects into the unfiltered region 104A. The fourth support 180D is disposed at or about an end of the first retainer wall 162 connected to the second portion 156B of the base body 156 and projects into the unfiltered region 104A. The fifth support 180E is disposed at or about an end of the second retainer wall 164 connected to the second portion 156B of the base body 156 and projects into the unfiltered region 104A.

A second exemplary module 200 is depicted in FIGS. 7-9. The module 200 includes a housing 102, a housing shell 130, a filter 150, an inlet 110, an outlet 120, one or more access openings 214A-214D, and a seal 126. With a few exceptions, including the configuration of the frame wall 170, the inlet openings 212, the access openings 214A-214D, and the addition of several clamping supports 284A-284D, described further below, the module 200 is substantially similar to and/or the same as the first exemplary module 100 of FIGS. 1-6.

The frame wall 170 is configured as and/or may be considered and/or referred to as a perforated frame wall 276. The frame wall 170 includes a perforated planar body 278 and the fixed-end second member 174A, free-end second member 174B, first-side first member 172A, and second-side first member 172B extend around a perimeter of and/or frame the perforated planar body 278. The perforated planar body 278 includes the inlet openings 212, which form and/or define the perforations of the perforated planar body 278. The inlet openings 212 are disposed in and defined by the perforated planar body 278. The inlet openings 212 are smaller (e.g., relative to the inlet openings 112 of the module 100), round and/or circular in shape, and arranged in a plurality of rows and columns that form a grid. The filter 150, filter frame 154, and/or frame wall 170 thus includes and/or defines the inlet 110 of the module 200.

In addition to the five supports 180A-180E, the filter frame 170 further includes a plurality of clamping supports 284A-284D (e.g., a first clamping support 284A, a second clamping support 284B, a third clamping support 284C, a fourth clamping support 284D). The clamping supports 284A-284D are structured as cylindrical and/or annular bodies rather than generally planar projections like the supports 180A-180E, which increases their overall strength and durability enabling them to be used to press the filter frame 154 against the housing shell 130 during the laser welding process. The clamping supports 284A-284D are disposed on, protrude from, and/or integrally formed with the base body 156 of the filter frame 154. Like the supports 180A-180E, the free end of each clamping support 284A-284D is disposed slightly spaced apart from the bottom wall 134 of the housing shell 130 (e.g., does not contact and/or abut the housing shell 130) or, alternatively, contacts and/or rests on the bottom wall 134 of the housing shell 130. The clamping supports 284A-284D are each arranged in alignment with a respective access opening 214A-214D, which are disposed in and defined by the bottom wall 134 of the housing shell 130. In other words, the housing shell 130 includes the plurality of access openings 214A-214D. The access openings 214A-214D are each arranged in alignment with and provide access to a respective clamping support 284A-284D of the filter frame 154 for clamping and/or pressing the filter 150 against the housing shell 130 while laser welding them together. Alternatively, the frame wall 170 and/or the perforated planar body 278 includes and/or defines a plurality of access openings similar to access openings 114A, 114B of module 100.

The first clamping support 284A is disposed at or about an end of the third portion 156C of the base body 156 connected to the first portion 156A, projects from the third portion 156C into the unfiltered region 104A, and is aligned with the first access opening 214A. The second clamping support 284B is disposed at or about an end of the fourth portion 156D of the base body 156 connected to the first portion 156A, projects from the fourth portion 156D into the unfiltered region 104A, and is aligned with the second access opening 214B. The third clamping support 284C is disposed at or about an end of the third portion 156C of the base body 156 connected to the second portion 156B, projects from the third portion 156C into the unfiltered region 104A, and is aligned with the third access opening 214C. The fourth clamping support 284D is disposed at or about an end of the fourth portion 156D of the base body 156 connected to the second portion 156B, projects from the fourth portion 156D into the unfiltered region 104A, and is aligned with the fourth access opening 214D. The clamping supports 284A-284D may, in some examples, each project into, be disposed at least partially within, and/or extend completely through the respective access opening 214A-214D.

During the laser welding process, clamping members are each inserted into a respective access opening 214A-214D to engage and/or contact the corresponding clamping support 284A-284D, and press against the clamping supports 284A-284D to clamp and/or press the filter frame 154 against the housing shell 130 (e.g., the perimeter wall 160 against the top wall 132) while laser welding the filter 150 and housing shell 130 together. The arrangement of the clamping supports 284A-284D at or about the corners of the filter frame 154 and/or base body 156 provides a more even and/or uniform pressure distribution when the filter frame 154 is pressed against the housing shell 130, resulting in a reduction in leakage and/or contamination potential (e.g., formation of an improved and/or more reliable seal between the housing shell 130 and the filter frame 154).

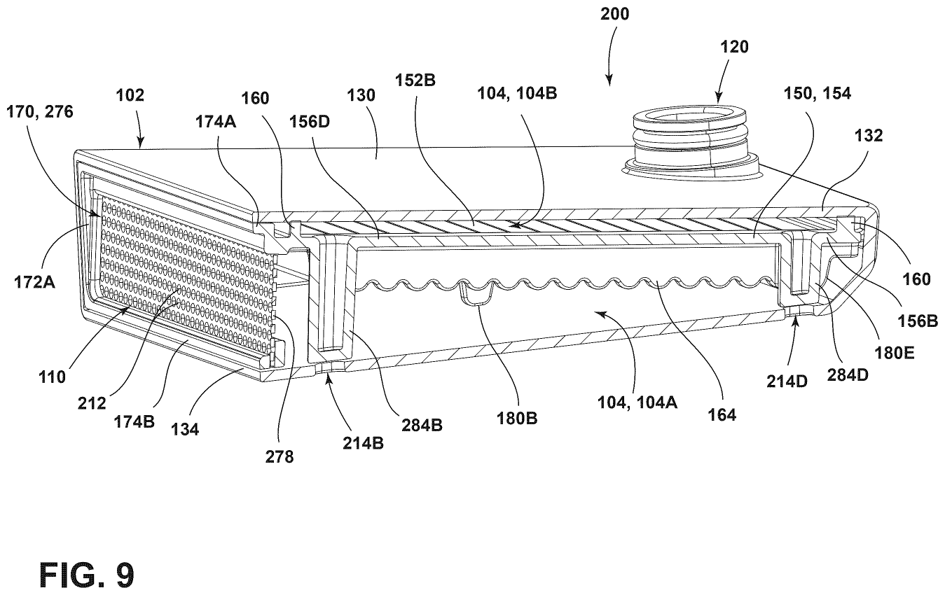

In some examples, the access openings 214A-214D remain open and unsealed (i.e., are not completely closed, covered, and/or sealed) once the filter 150 and housing shell 130 have been connected (e.g., after being laser welded together). The clamping supports 284A-284D may, in such examples, be disposed slightly spaced apart from the bottom wall 134 of the housing shell 130 (see, e.g., FIG. 9). Alternatively, the clamping supports 284A-284D may contact and/or rest on the bottom wall 134 of the housing shell 130 and may cover (e.g., partially and/or completely) the access openings 214A-214D without sealing the access openings 214A-214D (e.g., the engagement and/or abutment of the clamping supports 284A-284D and the bottom wall 134 does not form a seal around the access openings 214A-214D).

In other examples, the access openings 214A-214D are closed, covered, and/or sealed once the filter 150 and housing shell 130 have been connected (e.g., after being laser welded together) to prevent fluid from exiting the housing 102 through the access openings 214A-214D (e.g., during operation). Optionally, the clamping supports 284A-284D each cover and seal the associated access opening 214A-214D (see, e.g., FIG. 11) when the filter 150 and housing shell 130 are connected (e.g., after being laser welded together). Alternatively, the clamping supports 284A-284D do not seal the access opening 214A-214D and one or more (e.g., each of) the access openings 214A-214D may be closed, covered, filled in, and/or sealed by a one or more bodies (e.g., a plate, one or more plugs, covers, and/or caps, etc.) and/or a sealant (e.g., sealing material and/or compound) after completion of the laser welding process.

A third exemplary module 300 is depicted in FIGS. 10 and 11. The module 300 includes a housing 102, a housing shell 130, a filter 150, an inlet 110, an outlet 120, one or more access openings 214A-214D, and a seal 126. With a few exceptions, including the configuration of frame wall 170 and the inlet openings 312, the module 300 is substantially similar to and/or the same as the second exemplary module 200 of FIGS. 7-9.

The frame wall 170 is configured as and/or may be considered and/or referred to as a solid frame wall 376. The frame wall 170 includes a solid planar body 378 and the fixed-end second member 174A, free-end second member 174B, first-side first member 172A, and second-side first member 172B extend around the perimeter of and/or frame the solid planar body 378. Unlike the first exemplary module 100 and the second exemplary module 200, the frame wall 170 and/or the solid planar body 378 does not include (e.g., is free of) openings, recesses, and/or similar structures and seals the open end 130A of the housing shell 130 in a fluid tight manner.

The inlet openings 312 are disposed in and defined by the bottom wall 134 of the housing shell 130. The inlet openings 312 are disposed adjacent to the open end 130A of the housing shell 130 between the first and second access openings 214A, 214B. Optionally, the inlet openings 312 are arranged one after another in a linear row between the first and second access openings 214A, 214B. Conceivably, the housing shell 130 may include a single elongated inlet opening as opposed to a plurality of inlet openings 312.

A fourth exemplary module 400 is depicted in FIGS. 12 and 13. The module 400 includes a housing 102, a housing shell 130, a filter 150, an inlet 110, an outlet 120, one or more access openings 214A-214D, and a seal 126. The module 400 is substantially similar to and/or the same as the third exemplary module 300 of FIGS. 10 and 11 except that the filter 150 further includes a magnet receiver 486 and one or more magnets 488, and the housing shell 130 includes a closure flange 442.

The filter 150 and/or the filter frame 154 further includes a magnet receiver 486 that is configured to receive and retain one or more magnets 488 that attract, draw out, and/or capture magnetic (e.g., ferrous) material and/or particles suspended in the fluid flowing through the module 400. The magnet receiver 486 is connected to the first portion 156A of the base body 156 and/or the frame wall 170. The magnet receiver 486 includes and/or defines a magnet receptacle that receives the one or more magnets 488. The magnet receiver 486 is configured and/or structured as a cage-like structure in the illustrative example, though other configurations are conceivable. The magnet receiver 486 has a single open end via which the magnets 488 are insertable into the magnet receptacle. The open end of the magnet receiver 486 is disposed adjacent to the first portion 156A of the base body 156. The open end of the magnet receiver 486 and/or the magnet receptacle is closed by the closure flange 442 of the housing shell 130, which projects from the top wall 132 at the open end 130A of the housing shell 130. When the filter 150 and the housing shell 130 are connected to one another, the closure flange 442 of the housing shell 130 is aligned with and closes the open end of the magnet receiver 486 and prevents the magnets 488 disposed therein from being removed.

A fifth exemplary module 500 is depicted in FIGS. 14-19. The module 500 includes a housing 102, a housing shell 130, a filter 150, an inlet 110, an outlet 120, one or more access openings 514A, 514B, and a seal 126. With the few exceptions described below, the module 500 is substantially similar to and/or the same as the first exemplary module 100 of FIGS. 1-6.

The end wall 540 of the housing shell 130 includes a single portion that extends substantially parallel to the open end 130A, in contrast to the housing shell 130 of the first exemplary module 100 of FIGS. 1-6 in which the end wall 140 has an angled and/or curved configuration. The top wall 132 includes a scoop portion 544 that projects from the top wall 132 in a direction away from the bottom wall 134. The scoop portion 544 is referred to as a “scoop portion” herein due to its similar shape and/or appearance to that of a hood scoop and/or a roof scoop of an automobile (e.g., car). The scoop portion 544 is disposed at or about a central region of the top wall 132. The scoop portion 544 has a top wall 544A, an end wall 544B, and two sidewalls 544C, 544D that each project from the top wall 132 of the housing shell 130. The end wall 544B of the scoop portion 544 is disposed adjacent to the outlet 120 and/or the end wall 540 and opposite the open end 130A of the housing shell 130. The top wall 544A of the scoop portion 544 extends transversely to the top wall 132 and the bottom wall 134 of the housing shell 130. Alternatively, the top wall 544A of the scoop portion 544 extends substantially parallel to the bottom wall 134 of the housing shell 130. The scoop portion 544 defines and/or delimits an auxiliary and/or extension region 504C of the internal space 104, which expands the volume of the filtered region 104B and receives at least a portion of the retainer walls 562, 564 and the filter media 152 of the filter 150. The auxiliary region 504C of the internal space 104 may be considered part of and/or form a portion of the filtered region 104B.

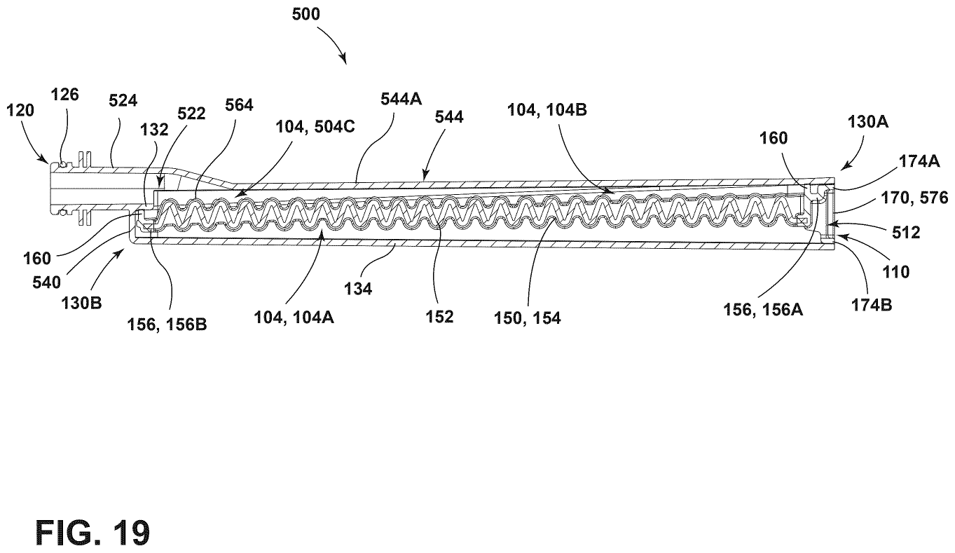

The outlet opening 522 is disposed in and/or defined by the scoop portion 544 of the housing shell 130 (e.g., the top wall 544A and end wall 544B) and the outlet connector 524 protrudes from the housing shell 130 (e.g., the scoop portion 544, the top wall 132, and/or the end wall 540) in a direction that is substantially parallel to the central longitudinal axis of the housing shell 130, substantially perpendicular to the open end 130A of the of the housing shell 130 (see, e.g., FIG. 19), and/or transverse to the top and bottom walls 132, 134.

Unlike some of the other exemplary modules 100, 200, 300, 400, the filter frame 154 does not include any supports 180A-180E, any clamping supports 284A-284D, nor a third retainer wall 166. However, a configuration in which the filter frame 154 of the module 500 includes one or more supports, one or more clamping supports, and/or one or more third retainer walls is conceivable. The filter frame 154 includes a first retainer wall 562 and a second retainer wall 564 that each project from the base body 156 into the unfiltered region 104A, (i.e., in a direction opposite the perimeter wall 160), the filtered region 104B, and the auxiliary region 504C of the internal space 104.

The frame wall 170 includes a fixed-end second member 174A, a free-end second member 174B, a first-side first member 172A, and a second-side first member 172B, which extend around and/or define an outer perimeter of the frame wall 170. The plurality of members includes a plurality of additional first and/or vertical members 172, but does not include any other and/or additional second and/or horizontal members 174. As such, the frame wall 170 may be considered and/or referred to as a slatted frame wall 576.

The inlet openings 512 are disposed in and defined by the frame wall 170. Each of the inlet openings 512 is formed and/or defined by the space and/or gap between two adjacent first members 172, the fixed-end second member 174A, and the free-end second member 174B. A first access opening 514A is formed and/or defined by the fixed-end second member 174A, the free-end second member 174B, the first-side first member 172A, and the first member 172C disposed directly adjacent to the first-side first member 172A. The second access opening 514B is formed and/or defined by the fixed-end second member 174A, the free-end second member 174B, the second-side first member 172B, and the first member 172D disposed directly adjacent to the second-side first member 172B. The filter 150, filter frame 154, and/or frame wall 170 thus includes and/or defines the inlet 110 of the module 500.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such elements. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

It should be understood that a controller, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A fluid filter module for a motor vehicle, comprising:
a cup-shaped housing shell;
a filter disposed at least partially in the housing shell;
the housing shell and the filter connected to one another and collectively defining a housing, the filter dividing an internal space of the housing into an unfiltered region and a filtered region;
the housing including i) an inlet via which a fluid is flowable into the unfiltered region and ii) an outlet via which the fluid is flowable out of the filtered region;
the filter including i) a filter frame and ii) a filter media configured to at least one of remove and collect impurities from the fluid, the unfiltered region and the filtered region fluidically connected to one another via the filter media; and
wherein the filter frame is connected to the filter media and includes a frame wall that closes an open end of the housing shell.

2. The fluid filter module according to claim 1, wherein the housing shell is a monolithic component.

3. The fluid filter module according to claim 1, wherein the housing further includes a plurality of access openings via which the filter is accessible to be at least one of clamped and pressed against the housing shell when connecting the housing shell and the filter to one another.

4. The fluid filter module according to claim 3, wherein the plurality of access openings open into the unfiltered region of the internal space.

5. The fluid filter module according to claim 3, wherein the plurality of access openings are disposed in and defined by the frame wall.

6. The fluid filter module according to claim 5, wherein the inlet includes a plurality of inlet openings that are disposed in and defined by the frame wall.

7. The fluid filter module according to claim 6, wherein the frame wall is one of a lattice frame wall, a perforated frame wall, and a slatted frame wall.

8. The fluid filter module according to claim 3, wherein the plurality of access openings are disposed in and defined by the housing shell.

9. The fluid filter module according to claim 8, wherein the inlet includes a plurality of inlet openings that are disposed in and defined by the housing shell.

10. The fluid filter module according to claim 8, wherein the frame wall is a solid frame wall and closes the open end of the housing shell in a fluid tight manner.

11. The fluid filter module according to claim 8, wherein:
the filter frame further includes a base body and a plurality of clamping supports projecting transversely from the base body; and
the plurality of access openings are each aligned with a respective clamping support of the plurality of clamping supports such that the plurality of clamping supports are accessible for at least one of clamping and pressing the filter against the housing shell when connecting the filter and the housing shell to one another.

12. The fluid filter module according to claim 1, wherein:
the filter frame further includes a base body and a perimeter wall projecting transversely from the base body;
the filter is connected to the housing shell via the perimeter wall; and
the perimeter wall is laser welded to the housing shell.

13. The fluid filter module according to claim 1, wherein the housing shell has a trapezoidal shaped cross-section in at least one plane extending perpendicular to the open end of the housing shell.

14. The fluid filter module according to claim 1, wherein the filter frame further includes a planar base body having a trapezoidal ring shape and that defines an opening in which the filter media is disposed.

15. The fluid filter module according to claim 14, wherein:
the base body includes a first portion, a second portion, a third portion, and a fourth portion;
the first portion is disposed adjacent to the open end of the housing shell;
the second portion is disposed opposite the first portion;
the third portion and the fourth portion extend between and connect the first portion and the second portion; and
a length of the first portion is greater than a length of the second portion.

16. The fluid filter module according to claim 15, wherein the filter frame further includes a perimeter wall projecting transversely from the base body, the perimeter wall laser welded to the housing shell and at least partially defining the filtered region of the internal space.

17. The fluid filter module according to claim 15, wherein:
the frame wall includes a plurality of access openings via which the filter is accessible to be at least one of pressed and clamped against the housing shell when connecting the housing shell and the filter to one another; and
the plurality of access openings includes:
a first access opening disposed in alignment with the third portion of the base body; and
a second access opening disposed in alignment with the fourth portion of the base body.

18. A fluid filter module for a motor vehicle, comprising:
a monolithic, cup-shaped housing shell;
a filter disposed at least partially in the housing shell;
the housing shell and the filter connected to one another and collectively defining a housing, the filter dividing an internal space of the housing into an unfiltered region and a filtered region;
the housing including i) an inlet via which a fluid is flowable into the unfiltered region and ii) an outlet via which the fluid is flowable out of the filtered region;
the filter including i) a filter frame and ii) a filter media configured to at least one of remove and collect impurities from the fluid, the unfiltered region and the filtered region fluidically connected to one another via the filter media;
wherein the filter frame includes a frame wall that closes an open end of the housing shell; and
wherein the housing further includes a plurality of access openings via which the filter is accessible to be at least one of pressed and clamped against the housing shell when connecting the housing shell and the filter to one another.

19. The fluid filter module according to claim 18, wherein:
the plurality of access openings open into the unfiltered region of the internal space; and
the plurality of access openings are disposed in and defined by at least one of the frame wall and the housing shell.

20. The fluid filter module according to claim 18, wherein the inlet includes a plurality of inlet openings that are disposed in and defined by at least one of the frame wall and the housing shell.
